(19) United States
(12) Patent Application Publication
(10) Pub. No.: US 2005/0077793 A1
(43) Pub. Date: Apr. 14, 2005

(54) Electrical machine having capability to generate lateral forces

(76) Inventors: Seamus Garvey, Bridgeford (GB); Wee Keong Khoo, Boeston (GB)

Correspondence Address: Zilka-Kotab, PC, P.O. BOX 721120, SAN JOSE, CA, 95172-1120, US

(21) Appl. No.: 10/491,508

(22) PCT Filed: Oct. 7, 2002
(86) PCT No.: PCT/GB02/04526

(30) Foreign Application Priority Data
Oct. 5, 2001 (GB) 0123927.6
Jun. 13, 2002 (GB) 0213625.9

(51) Int. Cl. H02K 7/09

(52) U.S. Cl. 310/90.5; 310/184

(57) ABSTRACT

This invention is a rotating electrical machine comprising two major components capable of relative rotation about a common axis and separated by an air gap in which magnetic fields linking the two main components through the air gap act both to exert torque and lateral forces. A set of windings is present on at least one of these components and this set of winding is used to generate a distribution of flux having two parts: the first part serving primarily to case torque and the second part serving to cause a net lateral force between the two main components. This machine uses the physical connection of the coils within the phases of the machine such that separate sources can be used for supplying currents for generating torque and lateral forces independently. The voltage and current ratings of the supply used for generating the lateral forces can both be substantially lower than the corresponding ratings of the supply used for generating the torque.

The present invention relates to rotating electrical machines with integrated magnetic bearings serving a dual capacity function, namely to generate torque and magnetically levitate the rotor.

The disadvantages posed by conventional bearings such as rolling element and oil film bearings, have opened the door to alternative approaches in certain applications which require higher rotational speed and extreme reliability. Magnetic bearings are a non-contacting technology employed to perform the same task as conventional bearings but with advantages due to their active nature. The active nature of magnetic bearings offers a higher level of control of rotor vibration, diagnostics and load measurement capabilities (Knopse & Collins, 1996). Among the advantages are: elimination of friction, wear and lubrication; high speed capability; ability to operate in higher temperatures; potential for vibration control; and longer life.

In order to levitate and position a rotor, the magnetic forces must be exerted along five axes, usually two perpendicular axes at each rotor end and a fifth axis along the rotor's rotational axis. Radial bearings are responsible for the levitation of the shaft in the plane of the two perpendicular axes. The axial or thrust bearing is used to counteract axial forces in both directions. The way they usually operate is by injecting currents into the coils such that a net attractive force is created to minimise the displacement of the rotor. Feedback control is indispensable for active magnetic bearings because they are inherently unstable. Sensors measure the position of the rotor and this signal passes through an anti-aliasing filter to eliminate high frequency noise. The controller then processes the filtered signal and sends request currents to the power amplifiers which in turn drive the coils.

When considering the use of magnetic levitation in conjunction with an electrical machine, it is natural to consider bearingless or self-bearing machines as an alternative. Bearingless machines are an advance which possess the capabilities of both magnetic bearing and motor to levitate the rotor and generate torque simultaneously. A bearingless motor can have a shorter shaft than a motor and bearing configuration, thus higher speed operations are possible. In addition to the advantages that conventional magnetic bearings possess, the bearingless motor has fewer components and therefore a reduction of cost is possible.

Early designs of bearingless machines involved the use of separate sets of windings for the levitation and torque production. Accordingly, one set of windings is the conventional motor windings for torque generation and the other set is known as position control windings. When the currents are not excited in the position control windings, the flux densities in the air gap are created solely by the motor windings. To produce lateral forces, the motor magnetic field in the air gap is deliberately unbalanced by the currents of the position control windings. This causes the flux density at a certain position to decrease while the flux density at the diametrically opposite position increases. As a result, a net lateral force is exerted on the rotor towards the position with a higher flux density. By further unbalancing the flux densities in the air gap at other poles, a net lateral force at any arbitrary direction can be produced.

The forces created by the presence of magnetic flux in a motor or magnetic bearing are found to be proportional to the square of the magnitude of magnetic flux. In a bearingless motor, these forces act across the air gap. The usual design practices for electric motors result in relatively high flux densities in the air gap for the torque-producing components of flux. It transpires that a relatively small amount of additional flux can create a significant difference in the local values of the square of the magnitude of flux. If the distribution of the additional flux is chosen carefully, a significant net lateral force can result. In the absence of any substantial torque-producing component of magnetic flux, the levels of levitation flux required to exert lateral forces are often found to be considerably higher.

At any instant in the operation of a rotating bearingless motor, the magnetic flux causing torque production, B_{Torq}(□), is some function of angular position, □, around the air gap. For the purposes of this discussion, we can consider B_{Torq}(□) to represent magnetic flux on any cylindrical surface dividing the air gap where this cylinder is concentric with the machine axis. We are implicitly assuming that the machine is prismatic in the sense that every slice through the machine normal to the axis of rotation looks identical. It is possible to conceive of bearingless rotating machines which are not prismatic but the principles established here require generalisation in those cases. At any angular position, □, on our notional cylinder, there may be flux in the radial and circumferential directions and strictly, we should use two quantities to represent the magnetic flux cutting the cylindrical surface. For compactness here, suppose that the flux density measure, B_{Torq}(□), represents the density of flux in a direction at some angle, □ to the radius. The equalities below must be true for all angles, \tilde{□} The inequalities must be true for at least some angles, \tilde{∇}

Often, but not always, B_{Torq}(□) has a fairly sinusoidal form
B_{Torq}(θ)˜B_{TorqMax} cos(N_{PPT}θ−ωt)

In this expression, N_{PPT} is the number of pole pairs of the torque-producing component of flux and □ is a frequency.

Let the additional magnetic flux distribution in the air gap for levitation purposes be denoted B_{Lev}(□). Then the total magnetic flux distribution in the air gap is
B_{Total}(θ)=B_{Torq}(θ)+B_{Lev}(θ)

It is desirable that the additional magnetic flux distribution due to the levitation field causes no change in torque. This is assured provided that . . .

$${{\int }_{0}}^{2 π} {( {B}_{Torq} ( θ ) + {B}_{Lev} ( θ ) )}^{2} \cdot ⅆ θ = {{\int }_{0}}^{2 π} {( {B}_{Torq} ( θ ) )}^{2} \cdot ⅆ θ$$

If the magnitude of B_{Lev}(□) is much smaller than the magnitude of B_{Torq}(□), the above is satisfied reasonably well by requiring simply that:

$${{\int }_{0}}^{2 π} {B}_{Torq} ( θ ) \cdot {B}_{Lev} ( θ ) \cdot ⅆ θ = 0$$

In order that the additional magnetic flux distribution due to the levitation field does cause some levitation, we require that either

$${{\int }_{0}}^{2 π} {( {B}_{Torq} ( θ ) + {B}_{Lev} ( θ ) )}^{2} \cdot sin ( θ ) ⅆ θ \neq 0$$

or

$${{\int }_{0}}^{2 π} {( {B}_{Torq} ( θ ) + {B}_{Lev} ( θ ) )}^{2} \cdot cos ( θ ) ⅆ θ \neq 0$$

A main priority in the design of bearingless machines will be that at least one of the above integrals will be substantial in magnitude for a given magnitude of B_{Lev}(□).

In the case where the torque-producing flux, B_{Torq}(□) has the sinusoidal form given above, it is found that the optimal distributions of levitation field are also approximately sinusoidal
B_{Lev}(θ)˜B_{LevMax}[a. cos(N_{PPL}θ)+b. sin(N_{PPL}θ)]
with N_{PPL}=N_{PPT}±1.

Several types of bearingless machines with two sets of coils have been patented. Williamson U.S. Pat. No. 4,792,710 disclosed a method of constructing polyphase bearingless machines by having a separate set of windings in the stator to exert a non-rotating lateral force on the rotor. The additional windings maybe arrange in any convenient way to generate the required levitation field. This levitation field rotates at the same direction and frequency as the main field and has pole number differing by two.

A variable-speed dynamotor having magnetic capability for suppressing vibrations and controlling the damping of the rotor was disclosed by Fukao et al. U.S. Pat. No. 5,880,550. This invention does not require the stator to be structurally modified, but only needs an additional winding to be wound around the stator. The levitation field also differs from the main motor field by a pole-pair. Fukao et al. U.S. Pat. No. 5,936,370 disclosed another rotating machine with position control windings. It includes a circuit for sensing the rotor displacement based on the induced voltage or current and the magnitude and speed of the rotating magnetic field.

Chiba et al. U.S. Pat. No. 5,955,811 disclosed a high speed rotary induction machine with position control windings fitted in the stator. The stator core has a four-pole stator winding and a two-pole position control windings and they are independently wound. The cage conductors of the rotor are designed such that the mutual inductance between the conductors and position control windings is zero in order to avoid excessive heating.

Osama et al. U.S. Pat. No. 6,034,456 disclosed a more compact bearingless machine with simplified fabrication techniques. This invention also has a separate position control windings wound in the stator. In one embodiment, the whole induction machine assembly comprises two stator and two rotor segments and an axial bearing to accomplish stable levitation. In another embodiment, the two rotor segments are offset with respect to stators to eliminate the use of an axial magnetic bearing. Such an arrangement is capable of generating axial forces to counter axial movement of the rotor when the coils are excited. For permanent magnet and synchronous machines, a single rotor segment extending from one stator segment to another may be used since there is no current flow in the rotor.

An integrated magnetic levitation and rotation system for semiconductor wafer processing was disclosed by Nichols et al. U.S. Pat. No. 6,049,148. Accordingly, the stator assembly has permanent magnets to levitate and passively centre a magnetic stainless steel rotor along the vertical axis. By energizing the stator position control coils, the interaction of fluxes generated by the control coils and DC flux produced by permanent magnets give rise to an active position control. Torque is developed when the polyphase drive coils are excited.

Satoh et al. U.S. Pat. No. 6,078,119 disclosed a bearingless induction machine with a second set of windings to levitate the squirrel-cage rotor. The magnetic flux distribution in the air gap is detected by integrating the counter-electromotive voltage induced in the stator winding.

The inventors addressed the difficulty of controlling the levitated rotor when a low frequency component is detected at an attenuated level. To substitute and compensate for the attenuated flux, the stator winding is supplied with a corrective current.

The purpose of employing two sets of windings is to superimpose two fields of different magnitude and pole number in the air gap, so as to generate torque and levitation simultaneously. It is evident that these bearingless machines have less torque capacity and are not cost effective. It is not always convenient to fit additional windings into conventional motors due to their physical dimensions. Further, if the stator is a custom-designed core, more space is required to accommodate two sets of windings which inevitably increases the size of the machine and cost of fabrication.

It is possible to achieve an equivalent magnetic field distribution in the air gap with only one set of windings where predetermined currents of different amplitude and phase relationship are supplied to the same set of windings to generate a superimposed magnetic field, and thus giving rise to torque and levitation. This method usually requires a number of power electronic devices to drive the independently wound stator coils. Here the torque and levitation-producing components of current are summed electrically in a controller before injecting into the terminal windings. Using a single set of windings for two functions is a more efficient solution and it presents an important concept in moving towards an integrated design.

Designs using a single set of windings have been proposed. Ohishi U.S. Pat. No. 5,237,229 disclosed a magnetic bearing device employing a rotating magnetic field. In this design, all coils wound on the stator are independently controlled by separate units of power amplifier. The rotor has surface mounted permanent magnets and is connected to a drive shaft of an external rig. Levitation is achieved by sequentially energising the coils so that a rotating magnetic field is produced to oppose and attract the polarities of the permanent magnets on the rotor.

Preston et al. U.S. Pat. No. 5,424,595 disclosed an integrated magnetic bearing and switched reluctance machine. The stator poles are wound with separately excitable phase windings and each winding is excited with a combination of motor phase and magnetic bearing currents. The force generated in each winding has a tangential and radial component to rotate and levitate the salient pole rotor respectively.

Mishkevich et al. U.S. Pat. No. 5,949,162 disclosed a method of damping and counteracting mechanical vibrations of an induction motor by means of inducing unbalanced forces on the motor shaft. In one example, the stator coils are divided into a 4 groups of star-connected coils in which each group is separately excited by a drive unit. By providing currents to all four groups of coils, the required four-pole rotating field is generated. Two sets of levitation fields (two-pole) that rotate at different frequencies and opposing each other are generated by selectively exciting the group of three-phase coils with appropriate frequency and phase relationships.

Maurio et al. U.S. Pat. No. 6,020,665 disclosed a permanent magnet synchronous machine with integrated magnetic bearings. The four-pole stator windings are split in half to form a 2-pole magnetic bearing winding and a four-pole motor winding. The windings are injected with currents having polarity relationship with the permanent magnets in the rotor so as to produce torque and levitation.

It can be seen that the prior art bearingless motors discussed above suffer from a number of drawbacks. Firstly, bearingless machines having separate sets of windings producing torque and bearing forces are not cost effective—they require extensive additional manufacturing effort and they deliver very poor specific power ratings as a result of additional space needed to accommodate the secondary windings. Secondly existing designs in which torque and bearing forces are generated by means of the same set of windings require the use of a high number of high-rated power-switching devices for the normal torque-producing function and the manner the machine is controlled is somewhat complicated.

Preferred embodiments of the present invention seek to overcome the above disadvantages of the prior art.

In particular, preferred embodiments of the invention seek to provide a bearingless rotating electrical machine that is capable of generating torque and lateral forces, utilising only a single set of windings. The same conductors within the set of windings may carry currents from the torque and lateral force-producing components simultaneously. This represents a more efficient use of the stator iron.

Preferred embodiments of the invention also seek to provide a bearingless rotating electrical machine that uses the physical connection of the coils within the phases of the machine such that separate inverters or supplies can be used for the torque and lateral force producing components of field. This machine benefits from being able to use only one standard supply for the normal torque-producing function of the machine and therefore, the usual way of motor control is preserved unlike the presently available bearingless motors with a single set of windings. Other drives employed are relatively low-rated power electronic devices for the achievement of lateral forces. In the presence of other suitable rotor support means, these low-rated power supplies can be switched off and the motor is driven by the conventional motor supply.

Preferred embodiments of the invention also seek to provide a connection scheme that is applicable to various types of motor or topologies.

Preferred embodiments of the invention also seek to provide a solution that can be extended to any polyphase machines such as two-phase, three-phase or higher phase machines.

Hereafter the terms “motor inverter” and “bearing inverter” will be used to mean the power supplies for producing torque and lateral forces respectively. Currents produced by the former and latter are known as “motor current” and “bearing current” respectively. Furthermore, the term “levitation” will be used frequently to mean producing a lateral force.

According to the present invention, there is provided a rotating electrical machine including:
a first component;
a second component adapted to be received by said first component and to rotate relative thereto; and
at least one set of windings provided on at least one of said first component and said second component, wherein at least one said set of windings includes a first electrical conductor and a second electrical conductor connected in series with said first electrical conductor, a third electrical conductor and a fourth electrical conductor connected in series with said third electrical conductor, and wherein the group consisting of said first electrical conductor and said second electrical conductor is connected in parallel to the group consisting of said third electrical conductor and said fourth electrical conductor, such that said conductors are adapted to conduct first electrical currents to generate a magnetomotive force tending to rotate the second component relative to the first component, and to conduct second electrical currents, applied through different terminals of the machine from those through which said first electrical currents are applied, to generate a magnetomotive force to produce a net translational force between the first component and the second component.

By providing a plurality of sets of windings, each of which has first and second windings connected in series, and third and fourth windings connected in series, the pair of first and second windings being connected in parallel with the pair of third and fourth windings, this provides the advantage that by arranging the magnitude of the second electrical currents supplied to the junction of the first and second windings, and to the junction of the third and fourth windings to be the same, the second electrical currents supplied to all four windings can be generated by a single current supply. This enables the number of current supplies used to be significantly reduced compared with prior art arrangements in which the motor torque and translational forces are generated by the same sets of windings. Also, by connecting the pair of first and second windings in parallel with the pair of third and fourth windings, this provides the advantage that the torque field produced by all four windings can be generated by the same power supply, for example a 3-phase power supply. Furthermore, by injecting the second currents through terminals different from those through which the first currents are introduced, this provides the advantage that the voltage and current rating of the current supplies providing the second currents can be significantly smaller than in the prior art.

In addition, by injecting the second currents at the junctions of the first and second, and of the third and fourth conductors, this provides the further advantage that the conductors of the machine can be provided in a symmetrical arrangement such that there is a substantial absence of coupling between the first and second currents. In other words, the levitation producing currents can be arranged to have negligible effect on the torque producing magnetomotive force (MMF), and the torque producing currents can similarly be arranged to have negligible effect on the MMF producing translational forces.

Said first and second electrical conductors and/or said third and fourth electrical conductors of at least one said set of windings may be adapted to receive said second electrical currents at a junction of said first and second electrical conductors and/or at a junction of said third and fourth electrical conductors, and to receive said first electrical currents at a junction of said first and third conductors and/or at a junction of said second and fourth conductors respectively.

At least one said first winding may comprise at least one respective coil arranged substantially diametrically opposite to the corresponding second winding comprising at least one coil and/or said third electrical conductor may be arranged substantially diametrically opposite to the corresponding said fourth electrical conductor.

It will be appreciated by persons skilled in the art that “diametrically opposite” in the present context means located on opposite sides of the axis of rotation of the first component relative to the second component.

Said first and fourth and/or said second and third windings of at least one said set of windings may be substantially co-axial to each other.

In the present context, it will be appreciated by persons skilled in the art that this means that the magnitude of the mutual inductance between these two conductors is close to 100% of its maximum value given the self-inductance of each of the two conductors.

This provides the advantage of enabling the first and third and/or the second and fourth windings of at least one set of windings to be wound on a single tooth, which in turn enables the number of teeth of the machine to be reduced. As a result, the number of coil turns on each tooth can be increased, which increases magnetomotive force for generating torque for a given size of machine, which in turn increases the efficiency of the machine.

In a preferred embodiment, said first component includes a plurality of teeth, and said first, second, third and fourth windings of at least one said set of windings each provide effective MMF for a respective plurality of said teeth.

The machine may comprise a plurality of said sets of windings, wherein a plurality of said sets of windings are adapted to generate respective said net translational forces in directions not parallel to each other.

In a preferred embodiment, a plurality of said sets of windings correspond to respective phases, and at least one said set of windings is connected in series or in parallel with a respective further set of windings of the same phase.

This provides the advantage of enabling more than one set of windings for each phase to be supplied with torque-producing electrical current by the same power supply, thus further reducing the number of power supplies required.

Said first and second and/or third and fourth windings of at least one set of windings may be connected in series to each other by means of respective connectors located externally of said first and/or second component.

This provides the advantage of minimising the extent to which the connectors between the windings affect magnetic flux density in the gap between the first and second components.

Said first and second and/or said third and fourth windings of at least one said set of windings may be connected in series with each other by means of further windings of the same phase.

This provides the advantage of maximising the efficiency of torque production of the machine by minimising the extent to which magnetic field is generated externally of the first component. For example, the return path connecting the first and second windings of one phase may be provided by a further winding of the same phase, so that the magnetic field generated by all of the windings appears across the gap between the first and second components.

The machine may further comprise control means for supplying said first and second electrical currents.

The machine may further comprise at least one position detector for providing an output signal to said control means representing the position of said second component relative to said first component.

The machine may further comprise at least one rotor speed detector for outputting an input signal to said control means representing the speed of rotation of said second component relative to said first component.

The bearingless machine described here comprises two major components—usually termed the rotor and the stator. It has windings on at least one of the major components. Most electrical machines are conventionally connected such that lateral forces are balanced even if an unbalanced supply is applied. This is achieved by using parallel connection of coils on diametrically opposite sides of the machine so that if one of these sees an unusually high or low current, its partner also sees this and the increase in net lateral force is zero.

The windings of virtually all electrical machines are organised into two or more separate phases. Each phase is an independent circuit which can carry current even if the other phases are open circuit. Each phase has two terminals. Sometimes, the ends of phases are connected together inside a machine but most commonly, all phase ends are brought out to the terminal box.

Each phase may comprise two or more parallel groups. In the present invention, we require that each phase comprises an even number of parallel groups. For simplicity of description, we assume that this number is two but the extension to higher numbers is straightforward.

Each group comprises a series connection of coils. In the present invention, we require that each group comprises an even number of series coils. For simplicity of description again, we assume that this number is two but the extension to higher numbers is straightforward. Cases where there are, say, 4 coils in a group are easily dealt with by considering certain pairs of coils to comprise a single “coil” in the following description.

In the present invention, currents are injected into the phase windings such that an unbalanced flux distribution occurs in the air gap, so as to produce a net lateral force in any desired arbitrary direction. The role of the bearing inverter is to inject differential currents into the windings in order to produce the requisite unbalancing of the flux distribution.

In the first embodiment the fundamental concept of the present invention is described. The principle of operation involves supplying currents from two separate sources to the fundamental connection so that the required magnetic polarities or flux distributions can be generated in the air gap.

A permanent magnet synchronous machine is given as an example in the second embodiment. The fundamental connection is extended to form a concentrated winding scheme producing a 4-pole motor field and a 2-pole levitation field in a 24-tooth stator. The rotor has surface mounted permanent magnets at an equiangular spacing around its periphery, forming the same number of magnetic pole pairs as the stator. External sensors are employed to give information on the rotor radial displacement and speed of rotation, which will then be processed by the controllers before sending out appropriate signals for switching the inverters. Separate inverters are used, namely a standard motor inverter and a number of small voltage and current ratings bearing inverters for producing the necessary currents to generate torque and lateral forces respectively. The third embodiment describes how the groups of parallel coils can be arranged to form the same MMF distribution in the air gap as in the second embodiment, but with an added advantage of reducing the required number of stator teeth by half. This is also a concentrated winding arrangement.

The possibility of extending to a double layer distributed winding arrangement, as commonly found in conventional electrical machines, is described in the fourth, fifth and sixth embodiments. These embodiments describe a means of generating a sinusoidal flux distribution in the air gap with a minimum number of bearing inverters. The fourth embodiment deals with a toroidal winding scheme which is best used in stators with a short axial length and large diameter to reduce the end winding effect. The fifth embodiment describes how the windings connection can be manipulated such that all conductors can be arranged within the stator slots, and thus removing the need for toroidally wound coils at the stator back core. A further manipulation of the connection is described in the sixth embodiment where it is possible to reduce the number of bearing inverters by at least half.

Preferred embodiments of the invention will now be described, by way of example only and not in any limitative sense, with reference to the accompanying drawings, in which:

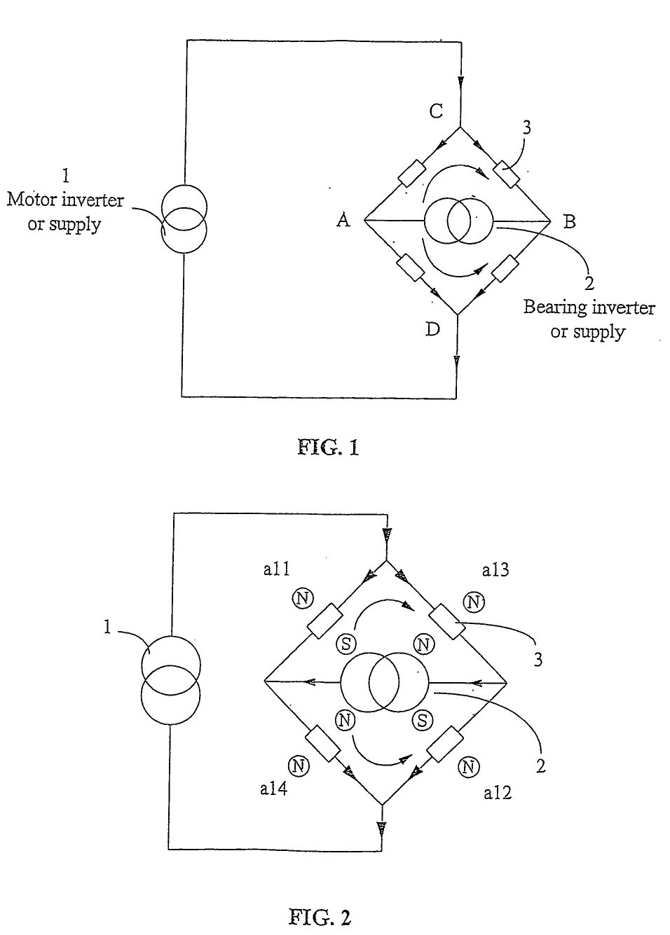

FIG. 1 is a circuit diagram of one phase of a bearingless electric motor of a first embodiment of the present invention;

FIG. 2 is a schematic representation of magnetic polarities produced by motor and levitation currents flowing in the loop connection of FIG. 1;

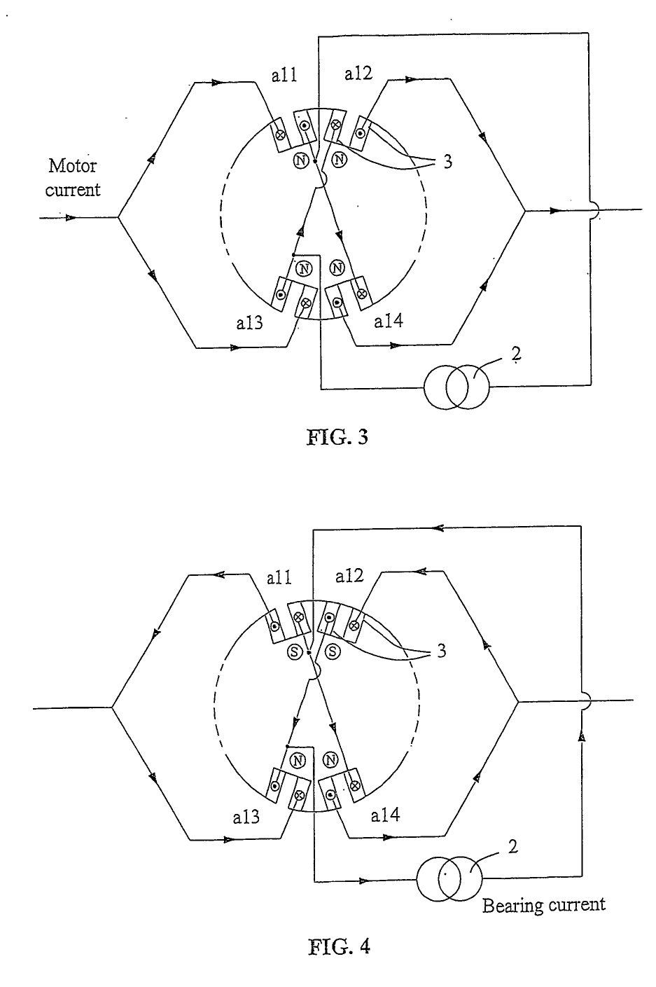

FIG. 3 is a schematic representation of a loop of FIG. 1 in which the same magnetic polarity is produced at diametrically opposite stator teeth when the motor current is excited;

FIG. 4 is a schematic representation of a loop of FIG. 1 in which opposing magnetic polarities are produced at diametrically opposite stator teeth when the levitation current is excited;

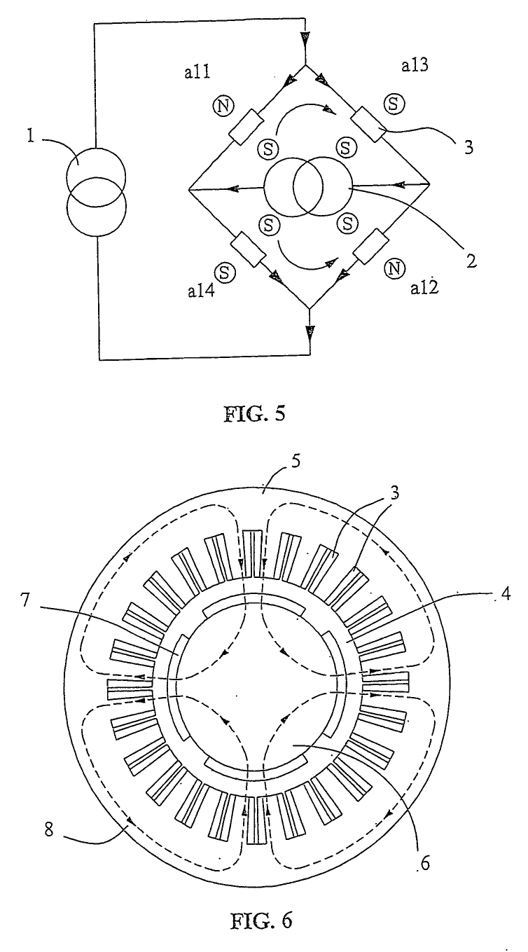

FIG. 5 is a schematic representation, corresponding to FIG. 2, but in which the polarity of a pair of coils is reversed;

FIG. 6 is a schematic representation of a three-phase permanent magnet synchronous motor of a second embodiment of the present invention;

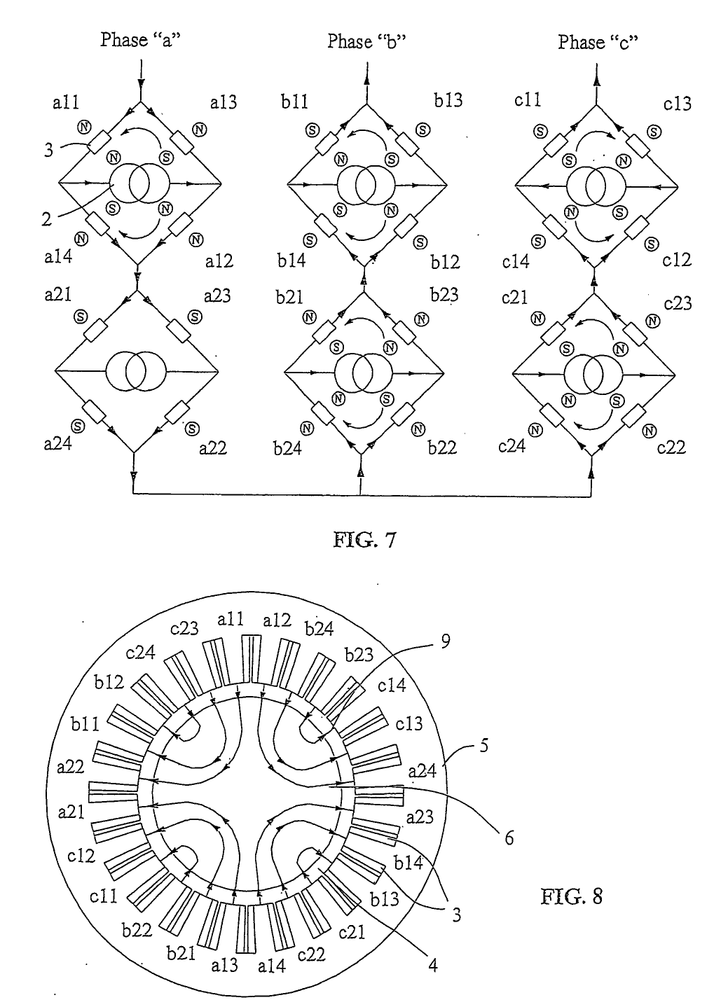

FIG. 7 is a schematic representation of a three-phase star connection of the embodiment of FIG. 6 showing instantaneous motor current and levitation current excitations;

FIG. 8 is a schematic cross sectional view showing a four-pole motor field generated in a 24-slot stator in the arrangement of FIG. 7;

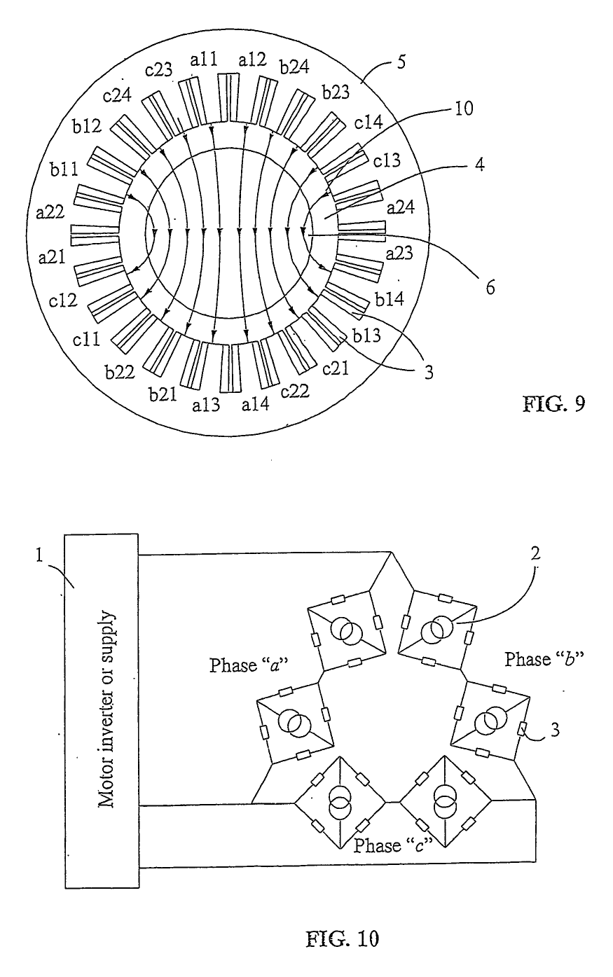

FIG. 9 is a schematic cross sectional view, corresponding to FIG. 8, showing a two-pole levitation field generated in a 24-slot stator in the arrangement of FIG. 7;

FIG. 10 is a schematic representation of a three-phase delta connection as an alternative to the star connection of FIG. 7;

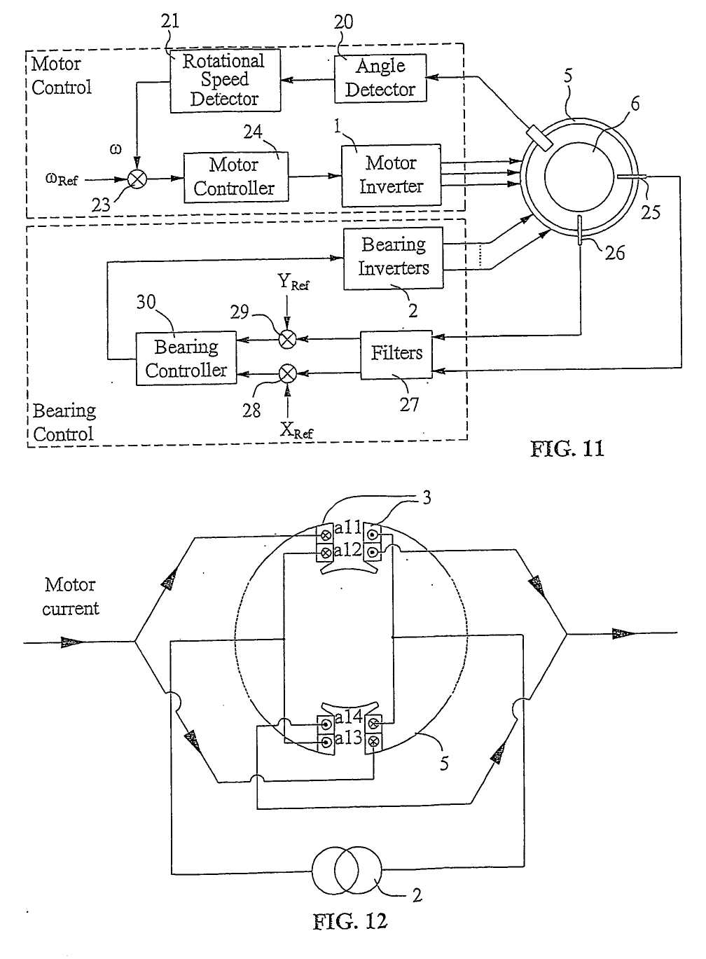

FIG. 11 is a schematic representation of a control system for use with the present invention;

FIG. 12 is a schematic representation of a coil arrangement of a third embodiment of the invention;

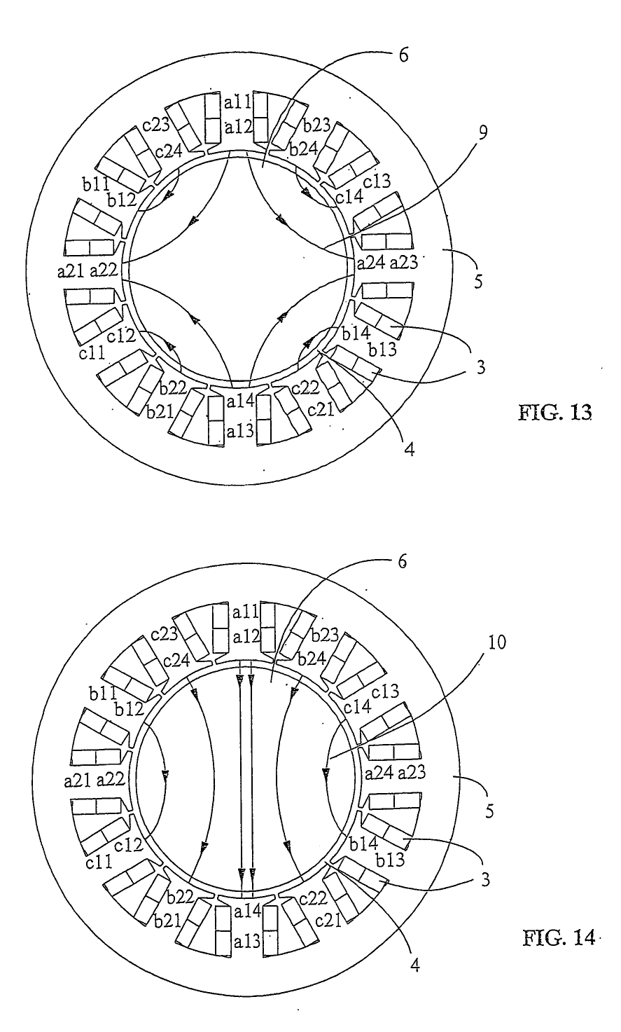

FIG. 13 shows a four-pole motor field generated in a 12-slot stator in the embodiment of FIG. 12;

FIG. 14 shows a two-pole levitation field generated in a 12-slot stator in the embodiment of FIG. 12;

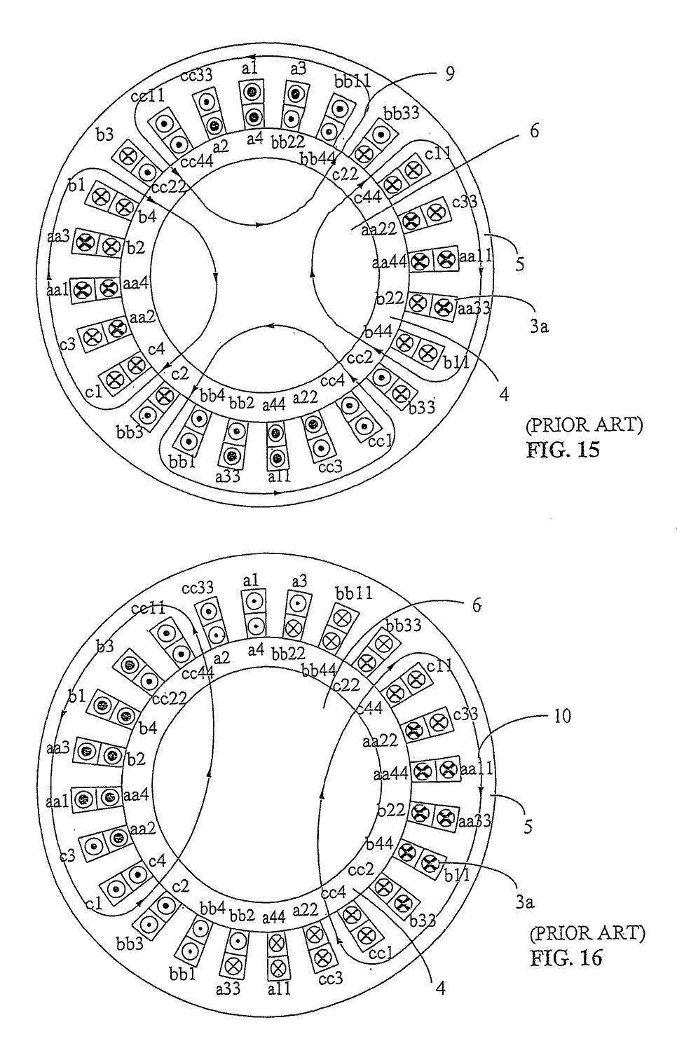

FIG. 15 shows a prior art distributed winding scheme producing a four-pole motor field;

FIG. 16 shows a prior art distributed winding scheme producing a two-pole levitation field;

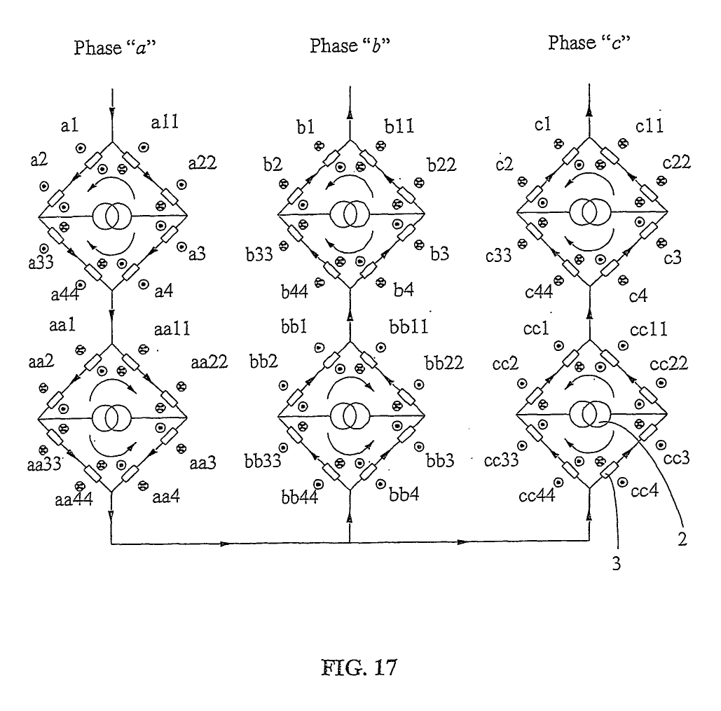

FIG. 17 is a schematic representation of a three-phase connection of a fourth embodiment of the invention showing instantaneous motor current and levitation current excitations;

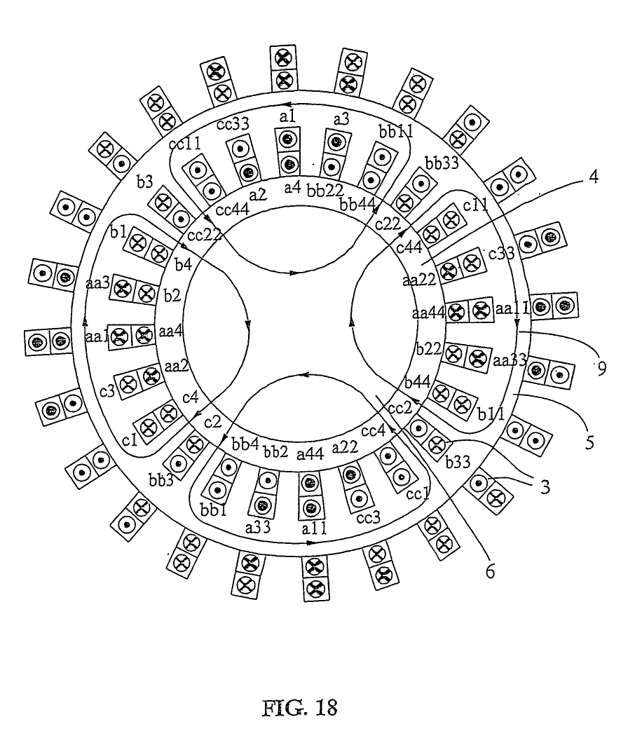

FIG. 18 shows a four-pole motor field generated by means of a toroidal winding arrangement in the embodiment of FIG. 17;

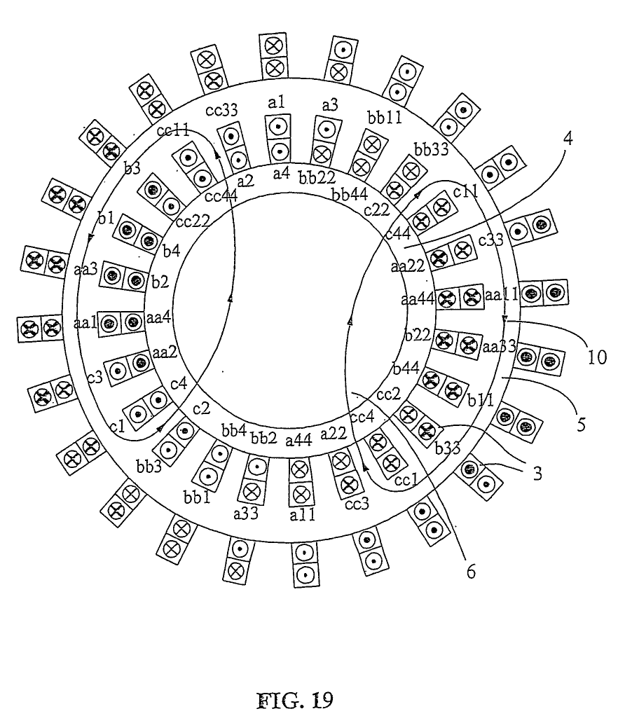

FIG. 19 shows a two-pole levitation field generated by means of a toroidal winding arrangement in the embodiment of FIG. 17;

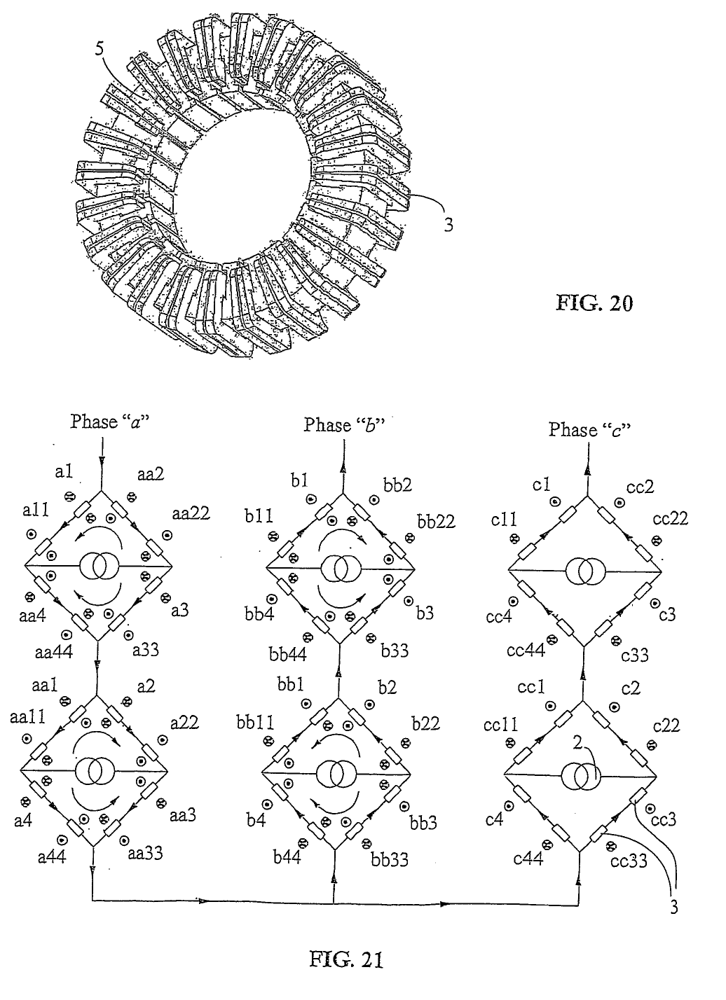

FIG. 20 is a perspective view of the toroidally wound stator of FIGS. 18 and 19;

FIG. 21 is a schematic representation of a three-phase connection of a fifth embodiment of the invention showing instantaneous motor current and levitation current excitations;

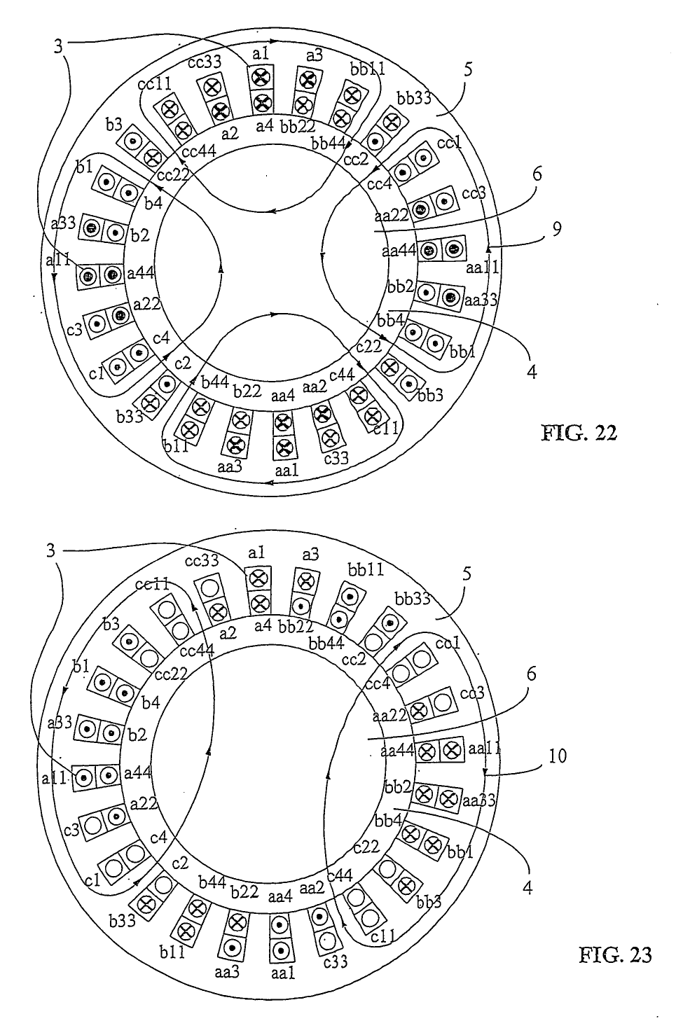

FIG. 22 shows a four-pole motor field generated by means of a distributed winding arrangement in the embodiment of FIG. 21;

FIG. 23 shows a two-pole levitation field generated by means of a distributed winding arrangement in the embodiment of FIG. 21; and

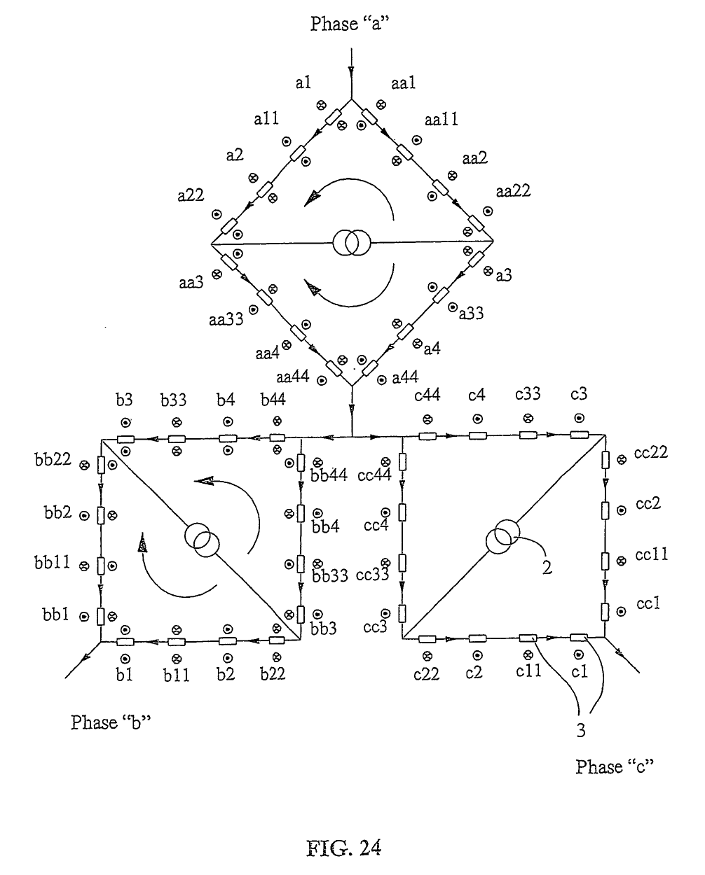

FIG. 24 is a schematic representation of a three-phase connection of a sixth embodiment of the invention showing instantaneous motor current and levitation current excitations.

The present invention is applicable to any type of polyphase machine and the principles of invention will now be described according to the preferred embodiments with reference to FIG. 1 to 24.

It is not uncommon in machine design to find that phases comprise several parallel groups of windings. The bearingless machines of this invention shown in FIG. 1 according to the first embodiment have each phase split into two parallel group; each of which comprises a series connection of two coils 3. Since all electrical machines have distinct phases with 2 ends to every phase, we can consider only one phase as shown in FIG. 1. The motor inverter 1 and bearing inverter 2 supply bi-directional currents for generating machine torque and lateral forces respectively.

In FIG. 1, the currents flowing in alms “CA”, “CB”, “AD” and “BD” are expected to be very substantial compared with the bearing current flowing in the branch “AB”. Likewise, the full voltage rating for the phase “CD” is expected to be very large compared with the voltage drop across “AB”. It is evident from the symmetry of the circuit that if the impedances of branches “CA”, “CB”, “AD” and “BD” are the same, the voltage drop across “CD” is independent of the current through “AB” and vice versa.

The issue about impedance mismatch in the connection can be resolved by ensuring that the voltage rating of the bearing inverter 2 must be sufficient to withstand the voltage that will exist across it. With this implementation, imbalanced currents that arise from the mismatch coil impedance can be prevented from flowing into the bearing inverter 2 and the current that the bearing inverter 2 injects must be trimmed accordingly to take account of the imbalance.

The significance of this connection is that the torque-producing component of current is split into two parallel paths in each phase and a bearing inverter 2 or supply between midpoints of each path in a loop-like configuration provides the currents which will be responsible for the levitation forces. FIG. 2 show how the motor and bearing currents flowing in the loop connection producing the magnetic polarities; the polarities as a result of motor and bearing currents excitation are labelled at the exterior and interior of the loop respectively. Accordingly, all coils 3 produce the same magnetic polarities N when a motor current is supplied, but when the bearing current is supplied, the polarities created at one pair of coils are of the opposite direction of the other pair. For the example given in FIG. 2 coils “a11” and “a12” have an S polarity while both coils “a13” and “a14” have an N polarity as far as the bearing current flow is concerned.

FIGS. 3 and 4 respectively depict how the coils 3 in FIG. 2 may be wound and arranged in a stator to produce N polarities at diametrically opposite stator teeth when the motor current is excited, but when the bearing current is excited, the polarities at diametrically opposite teeth are of the opposite to each other. Such current or polarity reversing properties are exploited to produce independent symmetrical torque and levitation-producing components of flux in the machine air gap. An alternative connection is shown in FIG. 5 where parallel coils “a11” and “a12” produce the same polarity but in the opposite to coils “a13” and “a14” when the motor current is supplied. Injection of bearing current will now result in the same polarity for all coils. This configuration can be thought as having the connection scheme in FIG. 2 being reversed inside out.

The usefulness of such a connection scheme will be more apparent when it is extended to form a three-phase machine according to the second embodiment. This particular embodiment is given as a crude example of how this invention can be realised. The machine in question is a 4-pole permanent magnet synchronous machine having an air gap 4 separating the stator 5 and the rotor 6 as illustrated in FIG. 6. The rotor has surface mounted permanent magnets 7 producing a 4-pole magnetic field 8. The terminals of the phase coils are connected to form a star connection as shown in FIG. 7. The instantaneous motor and levitation currents producing the corresponding 4-pole motor field 9 and 2-pole levitation field 10 are shown in FIGS. 8 and 9 respectively. Note that the fluxes flowing around the stator back core-are omitted for clarity. Levitation forces are created through the interaction of a 4-pole main field, which consists of the fields contributed by the permanent magnets 7 and motor inverter 1, with a either 2-pole levitation field 10 or a 6-pole levitation field; but the 2-pole field is chosen for the present invention. It is preferable to utilise the same rotating frequency for both motor and bearing currents for ease in levitation control.

In what follows, the description of coils arrangement in the stator is confined to phase “a” coils since the connections of phases “b” and “c” are similar to that of phase “a”. Accordingly, the set of coils 3 (forming an independent loop) in one phase described in the first embodiment are connected in series to another set to form phase “a”. The coils 3 are arranged such that one set of four coils in the top loop (“a11”, “a12”, “a13” and “a14”) gives an N polarity while the other set of four coils (“a21”, “a22”, “a23” and “a24”) gives an S polarity when a positive direction motor current flows. The magnetic polarities caused by the motor and bearing currents are shown at the exterior and interior of the loops respectively in FIG. 7. These polarities are interchanged when a reverse direction of current is flowing. For the present arrangement coil-pairs “a11”-“a12” and “a13”-“a14” produce equal magnitude but opposite direction of differential bearing currents flow with respect to each other. The same current attributes also apply to coil-pairs “a21”-“a22” and “a23”-“a24” of the bottom loop of phase “a”.

The significance of such a connection scheme can be perceived by considering the number of times the polarity changes per phase when a round trip along the periphery of the air gap 4 interface is undertaken. Since this is a 4-pole motor a round trip yields four times of polarity change per phase. The imposed 2-pole levitation field 10, however, yields only twice polarity change per phase, which implies that coil-pairs “a11”-“a12” and “a21”-“a22” must be diametrically opposing coil-pairs “a13”-“a14” and “a23”-“a24” respectively. In addition, the two groups of coils 3 in the top and bottom loops of phase “a” must be orthogonal to each other.

For a permanent magnet bearingless motor, lateral forces are predominantly caused by the interaction between the permanent magnet field 8 and the excited levitation field 10. The field created by the surface mounted permanent magnet 6 around the air gap periphery 4 is unbalanced by the levitation field 10 and thereby causing a net lateral force exerted on the rotor 6. To control the lateral force, a minimum of two levitation MMF axes must be present at any operating instant such that the linear combination of these independent levitation MMFs will give rise to a resultant MMF in any arbitrary direction.

As an alternative configuration, the phase coils 3 can also be connected to form a three-phase delta connection in FIG. 10. The method of loop connection in the present invention preserves the flexibility of having star- or delta-connections and concurrently serving to offer locations for injecting currents to exert lateral forces on the rotor 6. As shown in FIGS. 7 and 10, each configuration requires 6 independent bearing inverters 2 for levitation. These bearing current sources have a phase difference relationship with each other so that the overall effect is to create the required number of pole field in the machine.

FIG. 11 shows a schematic block diagram of the control system employed to drive the motor and produce lateral forces which may be divided into two groups, namely motor control and magnetic bearing control. The synchronous machine is provided with sensors 20 and 21 that detect the angular positions and rotational speed of the rotor 6. In order to control the speed and torque of the motor, the signal ω from the speed detector 21 is compared with the command signal ω_{Ref} in the comparator 23 and the resultant difference signal is input into the motor controller 24 which then calculates the required frequency and amount of current to be supplied to the motor. The corresponding request signal is then sent to the motor inverter 1 to switch the magnitude and direction of the currents.

Two discrete position sensors 25 and 26 located at orthogonal positions are employed to detect the displacement of the rotor 5 and signals are input into a filter 27 to eliminate high frequency noise. The desired horizontal (x_{Ref}) and vertical (y_{Ref}) rotor positions are then compared with the signals (x and y) from sensors 25 and 26 in the comparators 28 and 29 and fed into a bearing controller 30. The bearing controller 30 calculates the required resultant force and its corresponding direction based on the compared signals and information such as: the rotor speed; rotor orientation; and the torque-producing component of current or flux. The magnitude and direction of the required force dictates how much current is needed for injection into each phase coil 3. Finally, the controller 30 sends request signals to the bearing inverters 2 which in turn inject differential currents into the phase coils 3. These bearing currents are superimposed on the motor currents in the same set of coils 3 to achieve lateral forces.

The third embodiment of the present invention is described with reference to FIGS. 12-14. FIG. 12 shows how coil-pairs “a11”-“a12” and “a13”-“a14” of the top loop in FIG. 7 can be wound around 2 stator teeth instead of 4 as described in the previous embodiment. Coils “a11” and “a12” are stacked up and aligned at the same axis of symmetry, thereby producing the same magnetic effect as having a single coil with twice number of turns. Another way of describing this is that each coil in a stator pole is split into two smaller coils with equal number of turns. However, unlike early bearingless motors that incorporate separate sets of windings for torque and lateral force generation, the conductors in the present machine carry both motor and beating currents simultaneously. Likewise, coils “a13” and “a14” are wound at the diametrically opposite tooth and their terminals are connected to coils “a11” and “a12” to form a loop.

A similar method of connection also applies other phases, so as to obtain the same MMF distribution in the air gap as the machine described in the second embodiment. FIGS. 14 and 15 show respectively the resultant motor field 9 and levitation field 10 generated according to the current excitations in FIG. 7. The advantage of the present invention in this embodiment is that the number of stator teeth required has been reduced by half and this allows the coil turns to be increased in each stator tooth. It is intuitively obvious that for the same number of conductors accommodated in the slot, the present invention in the third embodiment will have a greater torque and lateral force producing capacity than conventional bearingless motors with dual set of windings.

The method of winding the stator for the present machine is most conveniently achieved by employing pre-wound coils where they can be placed or removed easily in the stator. The use of pre-wound coils, however, depends primarily on the physical geometry or shape of an individual stator tooth. The same control system described in the second embodiment also applies to present invention in the third embodiment.

In the previous embodiment, concentrated coils are wound on the stator teeth producing both 4pole motor and 2-pole bearing fields. Since the number of teeth is relatively small, the flux distributions in the air gap periphery as a result of current excitation are of a rectangular shape to some extent. This is also true for the back-EMF generated in each phase winding when the rotor shaft is rotated by an external drive. It is natural, therefore, to suppose that with a higher number of stator teeth and independent current loops, an improved sinusoidal flux distribution can be achieved. However, there are costs associated with having more bearing supplies if more independent current loops are required. For example, a 24-tooth stator with concentrated coils connected according to the method described in the third embodiment would demand 12 independent bearing supplies to give a better sinusoidal waveform. There is a motivation to develop an alternative winding method to obtain a sinusoidal flux distribution with minimal additional power electronic devices.

Using the principle described in the first embodiment as a basis, the fourth embodiment herein describes how coils can be arranged to form an equivalent double layer distributed winding. Double layer distributed windings are very common in electrical machines where the windings are overlapped and continuous from one phase to another. These machines cannot be turned into bearingless motors by merely injecting the appropriate magnitude and phase combinations of motor and bearing currents into the terminals. It is also important to note that such conventional windings cannot be incorporated in conjunction with the present wiring scheme because the windings need to be broken to permit bearing current injections. From a 2D-magnetostatic point of view, the windings described in the fourth embodiment herein will produce the same result as a conventional 4-pole motor with double layer distributed winding. A 24-tooth stator is considered as a design example.

As a design aid, the properties of diametrically opposing teeth or slots in relation to the pole number, flux density and current density are firstly reviewed. Accordingly, a 4(1+N) pole flux gives rise to the same magnitude and direction of flux densities at diametrically opposite teeth, whereas a 2(1+2N) pole flux would give the same magnitude but opposite direction of flux densities. Here N is an integer 0, 1, 2, 3, etc. The same rule also applies to the current carrying conductors: the same magnitude and direction of current densities at diametrically opposite slots generate a 4(1+N) pole field, whereas the same magnitude but opposite direction of current densities generate a 2(1+2N) pole field. With this understanding the actual winding can be derived based on the fundamental concept presented in the first embodiment.

It is most appropriate to consider conventional windings in a 2D plane to begin with. FIGS. 15 and 16 of the prior arts show the same set of double layer winding with distributed current densities in the stator slots producing 4- and 2-pole fields respectively. For the purpose of clarity only a minimum number of flux lines are drawn. As far as a 2D plane with neglected end effects is concerned, the same motor or levitation fields can be produced so long as the distributed current densities are applied as in FIGS. 15 and 16. Consequently there are countless methods of winding the stator. Specifying that the same conductors must carry both motor and bearing currents simultaneously has inevitably placed a restriction on how the stator can be wound.

It is evident from FIGS. 15 and 16 that some conductors in the adjacent slots carry the same magnitude of currents which means that it is possible to supply these conductors with only one common current source. With reference to the aforementioned properties of the diametrically opposing slots, coils “a1”→“a4” and “a11”→“a44” can be linked together to form an independent current loop. Similarly, coils “aa1”→“aa4” and “aa11”→“aa44” can be associated to form another independent loop. Both current loops form phase “a” winding. Phase windings “b” and “c” provide two independent current loops each with the same method of connection as in phase “a”. FIG. 17 illustrates the motor and bearing currents in all phases at one instant of time where the directions of motor and bearing currents, whether flowing in “go” or “return” slots, are shown at the exterior and interior of the current loops respectively. Note that only coil sides that produce the fields in FIGS. 15 and 16 are shown in the connection diagram. All other associated go or return paths are omitted for clarity reasons, for example, coil “aa1” of a go path is directly linked to coil “aa2” of the same path without undergoing a return path explicitly. A total of six independent bearing inverters 2 are used in the present embodiment. It is also possible to reduce the number of bearing inverters 2 to four or two so long as they are properly controlled to produce two independent levitation MMF axes. Nevertheless, with more bearing inverters 2 used, the system has a degree of fault tolerance.

Since diametrically opposing coil sides in the stator slots have the same magnitude and direction of current densities, and form an independent current loop, there is a space constraint on where the respective go and return paths should be placed in the slots. These go and return paths produce their own magnetic fields and strictly speaking, they must not interfere with the motor and bearing fields in the air gap. This requirement can be achieved by using a toroidal or Gramme winding scheme where the go and return paths are located at the exterior of the stator 20, as shown in FIGS. 18 and 19. Thus, the flux crossing the air gap 4 from the stator 5 to rotor 6 will not be affected. Both FIGS. 18 and 19 illustrate that one coil side is placed on top of the other coil side in each stator slot. In the actual arrangement, however, two coils 3 are connected and wound side by side around the stator back core 5 in each slot so as to keep the bridge balanced. FIG. 20 depicts the toroidal winding scheme according to the fourth embodiment. Toroidal windings are best used in stators with a short axial length and large diameter and thus, there is a reduction of end winding. However, a toroidal winding scheme may be unattractive because the coils wound around the back of the stator core can prevent heat from dissipating.

The fifth embodiment describes how the connection can be manipulated so that the need for toroidally wound coils at the stator back core can be eliminated, and thus moving towards a more conventional distributed winding arrangements. If the coils are connected such that each arm of the loop connection consists of two coil sides at 90° apart in the stator slots (as opposed to 180° diametrically opposite), then all conductors can be arranged within the stator slots. FIG. 21 illustrates the modified connection scheme according to the present embodiment producing a 4-pole motor field 9 and a 2-pole levitation field 10 in FIGS. 22 and 23 respectively. As before, the directions of the motor and levitation currents are shown at the exterior and interior of the loop respectively. Slots “a1” and “a11” represent the sides of one coil 3 where the copper conductor goes into slot “a1” and returns via slot “a11” making a number of turns. Any current injected in a coil side of that coil 3 will result in an opposite direction of current flow in the other coil side. Another coil 3 of the same direction of current flow linking slots “a3” and “a33” is connected at the opposite of the loop since both coils have the same current reversing property. Two more coils linking slots “aa2”-“aa22” and “aa4”-“aa44” are then connected to coils “a1”-“a11” and “a3”-“a33” forming a complete loop as depicted in FIG. 21 and therefore, a total of 8 coil sides or 4 separate coils 3 constitutes a single loop.

Since it is required that 16 coil sides to constitute a phase, each phase is extended to 2 series connected loops. It can be seen that the circuit connection method and the number of power supplies are retained, i.e. one standard 3-phase motor supply 1 and six bi-directional levitation current supplies 2. As before the number of levitation supplies 2 may be reduced if required. Unlike the previous embodiment where each loop controls the current in diametrically opposite slots or teeth, the present variant connection controls the current in all coil sides within a loop itself. Note that the resultant 4-pole motor field 9 is of the same distribution as the toroidal winding arrangement in the fourth embodiment would produce.

A net lateral force can be generated by appropriately exciting the phase levitation currents in any combination so long as the resultant field around the air gap is of a 2-pole. It is important that at least two levitation MMF axes are generated so as to enable the control of force in any magnitude and arbitrary direction. The present scheme may not create a sinusoidal levitation field 10 as perfectly as its predecessor in the fourth embodiment because of the way it is connected. For example, when all phases are excited, the resulting levitation field 10 will have a slight notch at its maximum peaks. Despite this minor imperfection the overall levitation field 10 still resembles a sinusoidal waveform and a net lateral force can be accomplished.

According to the sixth embodiment of the present invention, because some coils 3 in each phase of FIGS. 22 and 23 have the same magnitude and direction of current, it is possible to combine these coils such that only one independent connection loop is formed in each phase. Such a variant connection is shown in FIG. 24 where two coils 3 are connected in series in each branch of the loop and so only three levitation supplies 2 are required as opposed to six. As before, the directions of the motor current are shown at the exterior of the loops whereas the levitation currents are shown at the interior. The resultant 4-pole motor field 9 and 2-pole levitation field 10 are equivalent to that of FIGS. 22 and 23 respectively. One of the bearing inverters 2 can be made redundant because two levitation MMF axes are sufficient to provide a net lateral force control in any arbitrary direction.

The general descriptions hereafter apply to all embodiments of the present invention.

The essential requirement for rotor levitation is to implement a ±1 difference of pole-pair between the motor field and bearing field. It is apparent that at any instant of time, not all independent loops need to be supplied with bearing currents to achieve levitation provided that the ±1 pole-pair rule is followed.

The motor field for generating torque depends on the type of machines and it is directly related to the MMF crossing the air gap interface between the stator and rotor. In permanent magnet machines, the net MMF is contributed mostly by the permanent magnets on the rotor, unless the stator is excited with a very high current. For an induction machine, the net MMF is contributed by the induced rotor currents and partly by the stator currents. Both ±1 pole-pair fields from the excited stator and induced rotor cause a net lateral force to occur. In contrast to permanent magnet and induction machines, the rotor of the switch reluctance machines is not excited by any means and so the stator alone contributes the net MMF. Experience suggests that the magnitude of the levitation field is almost a hundred times smaller than the motor field and so there is no concern of exciting the magnetic material to saturation. Moreover, the losses due to the levitation currents are negligible when compared to motor currents.

As in the case of a motor and magnetic bearings assembly, the rotor of a bearingless motor must be exerted by magnetic force along five axes, namely two orthogonal axes at each end and a fifth axis along the rotor's rotational axis. Therefore, two segments of bearingless motors and an axial magnetic bearing are required for full stabilisation. The generation of unbalance lateral force is not only limited to providing necessary support to the rotor, but it also serves as a fault tolerant active magnetic bearing. Excessive vibrations can be counteracted by varying the loop currents, which in tarn control the stiffness and damping of the integrated magnetic bearing.

The present invention described in the preferred embodiments offers an optional secondary function, namely to generate unbalance forces, while serving the primary function of torque production. This feature is of paramount importance because in the case where a suitable means of rotor support is available, the motor can be run as a standard machine using only one standard power supply. Such a concept is applicable to various machines where a set of windings is present on at least one of the main components. Although the preferred embodiments describe a generic 3-phase bearingless machine, it is relatively straightforward to extend the connections to other polyphase machines such as 2, 4, 5, 6, 12 or higher phases.

It will be appreciated by persons skilled in the art that the above embodiments have been described by way of example only, and not in any limitative sense, and that various alterations and modifications are possible without departure from the scope of the invention as defined by the appended claims. In the foregoing preferred embodiments, only a few examples of the invention are described and illustrated. Nevertheless the fundamental concept of the present invention can be expanded and manipulated by those skilled in the art to conform to their specific machine requirements. It is the intention of the appended claims to embrace all such manipulations and modifications made to the actual scope of invention.

U.S. Patent Documents:

| | | |
|---|---|---|
| 4,792,710 | Dec. 20, 1988 | Williamson |
| 5,237,229 | Aug. 17, 1993 | Ohishi |
| 5,424,595 | Jun. 13, 1995 | Preston et al. |
| 5,880,550 | Mar. 9, 1999 | Fukao et al. |
| 5,936,370 | Aug. 10, 1999 | Fukao et al. |
| 5,949,162 | Sep. 7, 1999 | Mishkevich et al. |
| 5,955,811 | Sep. 21, 1999 | Chiba et al. |
| 6,020,665 | Feb. 1, 2000 | Maurio et al. |
| 6,034,456 | Mar. 7, 2000 | Osama et al. |
| 6,049,148 | Apr. 11, 2000 | Nichols et al. |
| 6,078,119 | Jun. 20, 2000 | Satoh et al. |

Other reference:

Knospe C. R. and Collins E. G., “Introduction to the special issue on magnetic bearing control”, IEEE Trans. Control Systems Technology, vol. 4, no. 5, pp. 481-483, September 1996.

1-15. (canceled)

16. A rotating electrical machine including:
a first component;
a second component adapted to be received by said first component and to rotate relative thereto; and
at least one set of windings provided on at least one of said first component and said second component, wherein at least one said set of windings includes a first electrical conductor and a second electrical conductor connected in series with said first electrical conductor, a third electrical conductor and a fourth electrical conductor connected in series with said third electrical conductor, and wherein the group consisting of said first electrical conductor and said second electrical conductor is connected in parallel to the group consisting of said third electrical conductor and said fourth electrical conductor, such that said conductors are adapted to conduct first electrical currents to generate a magnetomotive force tending to rotate the second component relative to the first component, and to conduct second electrical currents, applied through different terminals of the machine from those through which said first electrical currents are applied, to generate a magnetomotive force to produce a net translational force between the first component and the second component.

17. A machine according to claim 16, wherein said first and second electrical conductors and/or said third and fourth electrical conductors of at least one said set of windings are adapted to receive said second electrical currents at a junction of said first and second electrical conductors and/or at a junction of said third and fourth electrical conductors, and to receive said first electrical currents at a junction of said first and third conductors and/or at a junction of said second and fourth conductors respectively.

18. A machine according to claim 16, wherein said first and second electrical conductors of at least one said set of windings each comprise at least one coil, and wherein said first electrical conductor is arranged substantially diametrically opposite to the corresponding said second electrical conductor and/or said third electrical conductor is arranged substantially diametrically opposite to the corresponding said fourth electrical conductor.

19. A machine according to claim 18, wherein said first and fourth and/or said second and third electrical conductors of at least one said set of windings are substantially co-axial to each other.

20. A machine according to claim 16, wherein said first component includes a plurality of teeth, and said first, second, third and fourth electrical conductors of at least one said set of windings are wound around separate teeth.

21. A machine according to claim 16, wherein said first component includes a plurality of teeth, and said first, second, third and fourth electrical conductors of at least one said set of windings each provide effective magnetomotive force for a respective plurality of said teeth.

22. A machine according to claim 16, wherein said first and second and/or third and fourth electrical conductors of at least one set of windings are connected in series to each other by means of respective connectors located externally of said first and/or second component.

23. A machine according to claim 16, wherein said first and second and/or said third and fourth electrical conductors of at least one said set of windings are connected in series with each other by means of further electrical conductors of the same phase.

24. A machine according to claim 16, comprising a plurality of said sets of windings, wherein a plurality of said sets of windings are adapted to generate respective said net translational forces in directions not parallel to each other.

25. A machine according to claim 24, wherein a plurality of said sets of windings correspond to respective phases, and at least one said set of windings is connected in series or in parallel with a respective further set of windings of the same phase.

26. A machine according to claim 16, further comprising at least one control apparatus for supplying said first and second electrical currents.

27. A machine according to claim 26, further comprising at least one position detector for providing an output signal to at least one said control apparatus representing the position of said second component relative to said first component.

28. A machine according to claim 26, further comprising at least one rotor speed detector for outputting an input signal to at least one said control apparatus representing the speed of rotation of said second component relative to said first component.

29. A machine according to claim 16, wherein said sets of windings are arranged such that said second electrical currents result in substantially no change in torque between said first and second components.
